(19) United States
(12) Patent Application Publication
(10) Pub. No.: US 2025/0280451 A1
(43) Pub. Date: Sep. 4, 2025

(54) RANDOM ACCESS CHANNEL DESIGN FOR LOW POWER WIDE AREA COMMUNICATIONS

(71) Applicant: Lenovo (United States) Inc, Morrisville, NC (US)

(72) Inventors: Hossein Bagheri, Dearborn Heights, MI (US); Vijay Nangia, Woodridge, IL (US); Karthikeyan Ganesan, Nauheim (DE)

(21) Appl. No.: 19/210,745

(22) Filed: May 16, 2025

(51) Int. Cl. H04W 74/0833; H04L 1/08; H04L 5/00; H04W 72/21

(52) U.S. Cl. CPC H04W 74/0833; H04L 1/08; H04L 5/0048; H04W 72/21

(57) ABSTRACT

Various aspects of the present disclosure relate to random access for low power wide area (LPWA) communications. A user equipment (UE) can determine a first set of physical uplink shared channel (PUSCH) occasions. Additionally, the UE can determine a first random access channel (RACH) occasion. Moreover, the UE can determine a second set of PUSCH occasions based at least in part on one or more of the first set of PUSCH occasions, the first RACH occasion, and a first PID associated with the first RACH occasion. Subsequently, the UE can transmit a first random access message during a random access procedure. The first random access message can include a preamble and an uplink data payload. The preamble can be transmitted during the first RACH occasion and the uplink data payload can be transmitted during the second set of PUSCH occasions. The preamble can be associated with the first PID.

### TECHNICAL FIELD

The present disclosure relates to wireless communications, and more specifically to random access for low power wide area (LPWA) communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to determine a first set of physical uplink shared channel (PUSCH) occasions. A number of PUSCH occasions of the first set of PUSCH occasions can be less than a total number of PUSCH occasions. Additionally, the UE can determine a first random access channel (RACH) occasion. A first preamble identifier (PID) can be associated with the first RACH occasion. Moreover, the UE can determine a second set of PUSCH occasions based at least in part on one or more of the first set of PUSCH occasions, the first RACH occasion, and the first PID associated with the first RACH occasion. At least one PUSCH occasion of the first set of PUSCH occasions can be different than the second set of PUSCH occasions. Subsequently, the UE can transmit a first random access message during a random access procedure. The first random access message includes a preamble and an uplink data payload. The preamble can be transmitted during the first RACH occasion and the uplink data payload can be transmitted during the second set of PUSCH occasions. The preamble can be associated with the first PID.

In some instances, the UE can determine a random access response window based at least in part on the second set of PUSCH occasions. Additionally, the UE can receive a second random access message during the random access response window.

In one embodiment, the second random access message can indicate a successful decoding of the uplink data payload. Additionally, the second random access message can further indicate a failure to match the first PID with a second PID. The second PID can be based at least in part on the uplink data payload. Moreover, the UE can transmit a third random access message that includes the first PID, wherein the third random access message excludes the uplink data payload.

In another embodiment, the second random access message can indicate an unsuccessful decoding of the uplink data payload. Additionally, the second random access message can further indicate a request to retransmit the uplink data payload. Moreover, the UE can retransmit the uplink data payload during a subset of the second set of PUSCH occasions.

In some instances, the UE can compute a value by applying a function to at least a portion of the uplink data payload. Additionally, the UE can determine the first PID based at least in part on the computed value. Moreover, the value can be a hash value, and the function can be a hash function.

In some instances, the UE can randomly select the first PID from a plurality of PIDs.

In some instances, the uplink data payload can include an indication that the first PID is selected randomly or selected based on the uplink data payload.

In some instances, the UE can determine a demodulation reference signal (DMRS) sequence for each PUSCH occasion of the second set of PUSCH occasions based at least in part on a mapping rule. Additionally, the DMRS sequence for each PUSCH occasion of the second set of PUSCH occasions can be based at least in part on the first PID and the first RACH occasion.

In some instances, the first random access message can include a DMRS sequence for each PUSCH occasion of the second set of PUSCH occasions.

In some instances, the UE can receive mapping information that maps a pair of RACH occasions and PIDs with a pair of PUSCH occasions and DMRS sequences. The first random access message can further include the DMRS sequences.

In some instances, the UE can receive mapping information that maps a set of PUSCH occasions with a pair of RACH occasion and PIDs. Additionally, One or more of the first set of PUSCH occasions or the second set of PUSCH occasions can be based at least in part on the mapping information.

In some instances, the UE can receive a random access configuration, wherein the random access configuration indicates one or more of the total number of PUSCH occasions or a plurality of PIDs. Additionally, the first PID can be selected from the plurality of PIDs.

In yet another embodiment, a processor (e.g., a standalone processor chipset, or a component of a UE) for wireless communication is described. The processor can include at least one controller coupled with at least one memory. The processor may be configured to, capable of, or operable to perform one or more operations as described herein. For example, the processor may be configured to, capable of, or operable to determine a first set of PUSCH occasions. A number of PUSCH occasions of the first set of PUSCH occasions can be less than a total number of PUSCH occasions. Additionally, the processor may be configured to, capable of, or operable to determine a first RACH occasion. A first PID can be associated with the first RACH occasion. Moreover, the processor may be configured to, capable of, or operable to determine a second set of PUSCH occasions based at least in part on one or more of the first set of PUSCH occasions, the first RACH occasion, and the first PID associated with the first RACH occasion. At least one PUSCH occasion of the first set of PUSCH occasions can be different than the second set of PUSCH occasions. Furthermore, the processor may be configured to, capable of, or operable to cause a transmission of a first random access message during a random access procedure. The first random access message includes a preamble and an uplink data payload. The preamble can be transmitted during the first RACH occasion and the uplink data payload can be transmitted during the second set of PUSCH occasions. The preamble can be associated with the first PID.

In yet another embodiment, a method performed or performable by a UE for wireless communication is described. The method may include obtaining a RACH configuration. The RACH configuration can define a plurality of preamble identifiers (PIDs). Additionally, the method can include determining a first set of PUSCH occasions. A number of PUSCH occasions of the first set of PUSCH occasions can be less than a total number of PUSCH occasions. Moreover, the method can include determining a first RACH occasion. A first PID can be associated with the first RACH occasion. Furthermore, the method can include determining a second set of PUSCH occasions based at least in part on one or more of the first set of PUSCH occasions, the first RACH occasion, and the first PID associated with the first RACH occasion. At least one PUSCH occasion of the first set of PUSCH occasions can be different than the second set of PUSCH occasions. Subsequently, the method can include transmitting a first random access message during a random access procedure. The first random access message includes a preamble and an uplink data payload. The preamble can be transmitted during the first RACH occasion and the uplink data payload can be transmitted during the second set of PUSCH occasions. The preamble can be associated with the first PID.

In yet another embodiment, a base station for wireless communication is described. The base station may be configured to, capable of, or operable to perform one or more operations as described herein. For example, the base station may be configured to, capable of, or operable to receive, from a UE, a first random access message during a random access procedure. The first random access message can include a preamble and uplink data payload. The preamble can be associated with a first PID. Additionally, the base station can decode the first PID from the first random access message. Moreover, the base station can determine a set of PUSCH occasions based on the decoded first PID. Furthermore, the base station can decode the uplink data payload based on the determined set of PUSCH occasions. The base station can determine, by applying a function to at least a portion of the decoded uplink data payload, a second PID. The base station can determine whether the first PID matches the second PID. The base station can generate a second random access message based on the determination of whether the first PID matches the second PID. Subsequently, the base station can transmit the second random access message to the UE.

In some instances, the base station can determine a random access response window based on the determined set of PUSCH occasions. Additionally, the second random access message can be transmitted during the random access response window.

In some instances, when the base station determines that the first PID does not match the second PID, the second random access message can include a confirmation that the base station has successfully decoded the uplink data payload in the first random access message. Additionally, the second random access message can further include an indication that the first PID does not match the second PID. Moreover, the second random access message can include a request for the UE to transmit a third random access message that includes the first PID and excludes the uplink data payload.

In some instances, when the base station determines that the first PID matches the second PID, the second random access message can include an indication that the first PID matches the second PID. Additionally, the second random access message can further include a confirmation that a random access procedure is successfully completed.

In some instances, the base station can determine that the decoded uplink data payload is corrupted. Additionally, the second random access message can be further generated based on the determination that the decoded uplink data is corrupt. Moreover, the second random access message can include an indication of an unsuccessful decoding of the uplink data payload. Furthermore, the second random access message can further include a request to retransmit the uplink data payload during a subset of the determined set of PUSCH occasions.

In yet another embodiments, a processor (e.g., a standalone processor chipset, or a component of a base station) for wireless communication is described. The processor may be configured to, capable of, or operable to perform one or more operations as described herein. For example, the processor may be configured to, capable of, or operable to receive, from a UE, a first random access message during a random access procedure. The first random access message can include a preamble and uplink data payload. The preamble can be associated with a first PID. Additionally, the processor may be configured to, capable of, or operable to decode the first PID from the first random access message. Moreover, the processor may be configured to, capable of, or operable to determine a set of PUSCH occasions based on the decoded first PID. Furthermore, the processor may be configured to, capable of, or operable to decode the uplink data payload based on the determined set of PUSCH occasions. The processor may be configured to, capable of, or operable to determine, by applying a function to at least a portion of the decoded uplink data payload, a second PID. The processor may be configured to, capable of, or operable to determine whether the first PID matches the second PID. The processor may be configured to, capable of, or operable to generate a second random access message based on the determination of whether the first PID matches the second PID. Subsequently, the processor may be configured to, capable of, or operable to transmit the second random access message to the UE.

In yet another embodiment, a method performed or performable by a base station for wireless communication is described. The method can include receiving, from a UE, a first random access message during a random access procedure. The first random access message can include a preamble and uplink data payload. The preamble can be associated with a first PID. Additionally, the method can include decoding the first PID from the first random access message. Moreover, the method can include determining a set of PUSCH occasions based on the decoded first PID. Furthermore, the method can include decoding the uplink data payload based on the determined set of PUSCH occasions. The method can include determining, by applying a function to at least a portion of the decoded uplink data payload, a second PID. The method can include determining whether the first PID matches the second PID. The method can include generating a second random access message based on the determination of whether the first PID matches the second PID. Subsequently, the method can include transmitting the second random access message to the UE. In some instances, the method can include determining a response window timeframe based on the determined set of PUSCH occasions. The second random access message can be transmitted by the base station during the response window timeframe.

### BRIEF DESCRIPTION OF THE DRAWINGS

FIG. 1 illustrates an example of a wireless communications system in accordance with aspects of the present disclosure.

FIG. 2 illustrates an example of four-step RACH procedure in accordance with aspects of the present disclosure.

FIG. 3 illustrates an example of two-step RACH procedure in accordance with aspects of the present disclosure.

FIG. 4 illustrates a flowchart of a method associated with a UE transmitting a first random access message (MsgA) during a first step of a two-step RACH procedure in accordance with aspects of the present disclosure.

FIG. 5 illustrates a flowchart of a method associated with a UE receiving a second random access message (MsgB) during the second step of a two-step RACH procedure in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrate a flowchart of method performed by a UE in accordance with aspects of the present disclosure.

FIG. 10 illustrate a flowchart of method performed by a NE in accordance with aspects of the present disclosure.

### DETAILED DESCRIPTION

An aspect of the present disclosure relates to techniques for enhancing RACH operations, such as a two-step RACH procedure for 5G and other radio access technologies beyond 5G (e.g., 6G). The two-step RACH procedure can be used by a UE to establish communication with a network (e.g., a base station). Compared to a four-step RACH procedure, the two-step RACH procedure can reduce access latency and signaling overhead. By reducing the number of required signaling exchanges from four to two, the two-step RACH procedure enables the UE to access the network more quickly. Additionally, reducing the number of messages transmitted by each of the UE and the NE reduces the likelihood of network congestion, especially in dense deployment scenarios. Additionally, with fewer transmission and reception operations, the UE and the NE consume less power. Moreover, in highly congested network scenarios, the two-step RACH procedure increases the probability of successful initial access compared to the four-step RACH procedure.

The UE can combine the first random access message and the third message of the four-step RACH procedure into a first random access message (e.g., MsgA) for the two-step RACH procedure. Additionally, the NE can combine the second random access message and the fourth random access message of the four-step RACH procedure into a second random access message (e.g., MsgB) for the two-step RACH procedure. While the two-step RACH procedure reduces access latency, it may cause challenges such as time misalignment and increased risk of collisions (e.g., preamble collisions), particularly when multiple UEs select and transmit the same preamble.

The techniques described herein can resolve the time misalignment and collisions. For example, the NE can assist in resolving collisions based on a mapping between RACH preambles and PUSCH occasions. Additionally, the UE can assist in reducing collisions by interleaving uplink data transmission across different set of PUSCH occasions. For example, the UE can determine a RACH PID based on an uplink (UL) message by using a hashing technique. Additionally, the NE can transmit mapping information to the UE. Moreover, the UE can determine, based on the RACH PID and the mapping information, a set of PUSCH occasions to transmit the uplink data. The UE can transmit a first random access message with the PID in a RACH occasion and the uplink data in the set of PUSCH occasions. By using mapping information, the UE and the NE can determine a mapping between a RACH occasion and PID pair and a PUSCH occasion. Once the NE has received the first random access message, the NE, using the mapping information, can decode the PID based on the set of PUSCH occasions.

From the UE perspective, the UE can determine a DMRS resource index based on the RACH occasion and PID. For example, the UE can associate a (RACH occasion, RACH preamble ID) pair to (PUSCH occasion, DMRS resource index) pair by using the mapping information. In some instances, multiple PUSCH occasions can be associated with a (RACH occasion, RACH preamble ID) pair. Multiple RACH occasions can be associated with a (PUSCH occasion, DMRS resource index) when the number of RACH preambles per RACH occasion is larger than the number of DMRS resource indices). Moreover, the UE can determine a set of reference PUSCH occasions based on a set of (RACH preamble-PUSCH occasion) association patterns corresponding to the set of reference PUSCH occasions. Furthermore, the mapping information can ensure that two non-consecutive frequency division multiplexing (FDM) PUSCH occasions belonging to the same time unit (e.g., 1 millisecond (ms), 0.5 ms, 0.25 ms, 0.125 ms) are not associated with a (RACH occasion, RACH preamble ID) pair for a subcarrier spacing (SCS) value (e.g., 15 KHz).

Additionally, in an unsourced multiple access channel (MAC) setup, the preamble can be determined based on the hashing of the message in a first random access message (e.g., MsgA in the two-step RACH procedure). Preamble selection techniques described herein can be utilized to reduce two UEs using the same preamble. In one example, a UE can randomly select a preamble, instead of having the preamble determined based on the uplink data in the message. When randomly selecting the preamble, the UE can use a set of time-frequency resources that is orthogonal to the resources used for preamble that are determined based on a message (e.g., MsgA). In another example, the preamble can be determined based on a different bitfield or different set of bits from a message (e.g., MsgA). In yet another example, a bitfield in a message (e.g., MsgA) can indicate the preamble selection scheme (e.g., hashing a first location of bits in the MsgA, hashing a second location of bits in the MsgA, or random preamble selection, RACH attempt number, backoff value).

From the NE perspective, the NE (e.g., a gNB) can process a first random access message (e.g., MsgA in the two-step RACH procedure) received from the UE, and generate a second random access message (e.g., MsgB of the two-step RACH procedure). The second random access message can include an indication of transmission of RACH preamble without MsgA. Additionally, the second random access message can include an indication of how many PUSCH occasions in the set of PUSCH occasions associated with a RACH preamble ID have to be retransmitted. In some instances, the second random access message can include an indication of which PUSCH occasions in the set of PUSCH occasions associated with a RACH preamble ID need to be retransmitted. In some instances, the second random access message can include an indication of what fraction (e.g., portion, subset, number) of PUSCH occasions in the set of PUSCH occasions associated with a RACH preamble ID need to be retransmitted. Additionally, the NE can determine a MsgB window based on a subset of PUSCH occasions associated with RACH preamble transmission.

Additionally, the UE and/or the NE can utilize different number of PUSCH occasions for transmitting the uplink data to enable configuration parameters of preamble grouping to serve different LPWA tiers and/or channel characteristics. Moreover, the UE and/or the NE can perform a preamble selection and associated configuration in case of backoff and/or additional RACH attempts. Furthermore, the UE and/or the NE can utilize a hashing design of MsgA to obtain the RACH preamble ID.

Aspects of the present disclosure are described in the context of a wireless communications system. Additional details of one or more implementations of the present disclosure are set forth in the accompanying drawings and the description below. Other aspects and advantages will become apparent from the description, the drawings, and the claims.

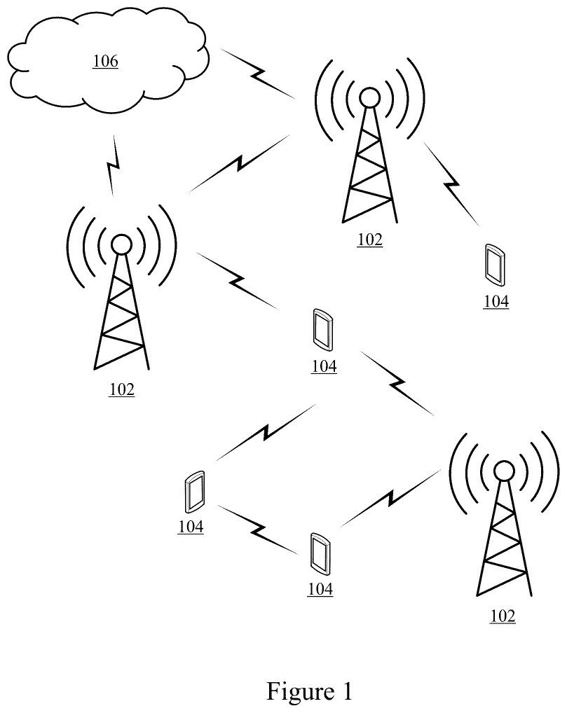

FIG. 1 illustrates an example of a wireless communications system 100 in accordance with example aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

In some implementations, an NE 102 may be implemented in a disaggregated architecture (e.g., a disaggregated base station architecture, a disaggregated RAN architecture), which may be configured to utilize a protocol stack that may be physically or logically distributed among multiple network entities (e.g., NEs 102), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), or any combination thereof. An RU may also be referred to as a radio head, a smart radio head, a remote radio head (RRH), a remote radio unit (RRU), or a transmission reception point (TRP). The split of functionality between a CU, a DU, and an RU may be flexible and may support different functionalities depending on which functions (e.g., network layer functions, protocol layer functions, baseband functions, RF functions, or any combinations thereof) are performed at a CU, a DU, or an RU.

One or more components of the NEs 102 in a disaggregated RAN architecture may be co-located, or one or more components of the NEs 102 may be located in distributed locations (e.g., separate physical locations). Additionally, or alternatively, in some examples, one or more of the NEs 102 of a disaggregated RAN architecture may be implemented as virtual units (e.g., a virtual CU (VCU), a virtual DU (VDU), a virtual RU (VRU)).

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

The wireless communications system 100 may be configured to support ultra-reliable communications or low-latency communications, or various combinations thereof. For example, the wireless communications system 100 may be configured to support ultra-reliable low-latency communications (URLLC). The UEs 104 may support ultra-reliable, low-latency, or critical functions. Ultra-reliable communications may include private communication or group communication. Support for ultra-reliable, low-latency functions may include prioritization of services, and such services may be used for public safety or general commercial applications. The terms ultra-reliable, low-latency, and ultra-reliable low-latency may be used interchangeably herein.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a CP. A first numerology (e.g., μ=0) may be associated with a first subcarrier spacing (e.g., 15 kHz) and a normal CP. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal CP. A third numerology (e.g., μ=2) may be associated with a third subcarrier spacing (e.g., 60 kHz) and a normal CP or an extended CP. A fourth numerology (e.g., μ=3) may be associated with a fourth subcarrier spacing (e.g., 120 kHz) and a normal CP. A fifth numerology (e.g., μ=4) may be associated with a fifth subcarrier spacing (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal CP, a slot may include 15 symbols. For an extended CP (e.g., applicable for 60 kHz subcarrier spacing), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

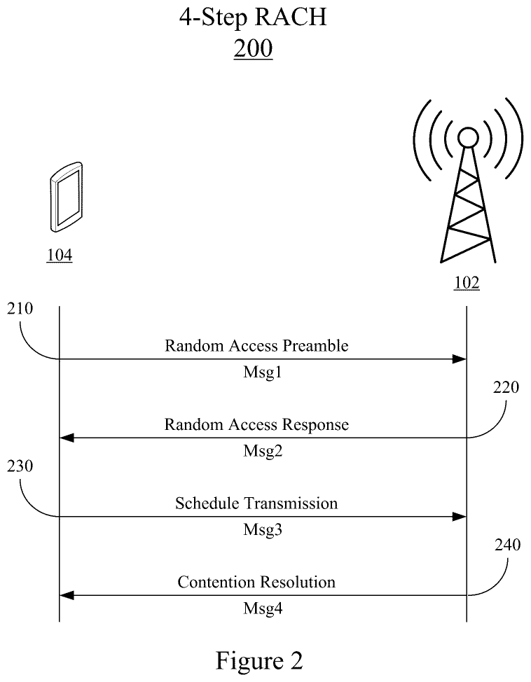

FIG. 2 illustrates an example of four-step RACH procedure in accordance with aspects of the present disclosure. A four-step RACH procedure 200 can include a first step 210, a second step 220, a third step 230, and a fourth step 240.

At the first step 210 of the four-step RACH procedure 200, the UE 104 can transmit a first random access message (Msg1) having a preamble. For example, the UE 104 can select a random access preamble from a set of predefined preambles. The set of predefined preambles can be of a short preamble format and a long preamble format. The UE 104 can also select a random sequence number for the preamble. After choosing the preamble and sequence number, the UE transmits the preamble on the physical RACH (PRACH).

At the second step 220 of the four-step RACH procedure 200, the NE 102 (e.g., 5G base station, gNB) can transmit a second random access message (Msg2) having a random access response. For example, upon receiving Msg1, the base station can send a response called the second random access message (Msg2). The second random access message (Msg2) can consist of several critical pieces of information, such as the Time Advance (TA) command for timing adjustment, the RAPID (Random Access Preamble ID) matching the preamble sent by the UE, and an initial uplink grant for the UE. The base station can also assigns a temporary identifier called RA-RNTI (Random Access Radio Network Temporary Identifier) to the UE 104.

At the third step 230 of the four-step RACH procedure 200, using the initial uplink grant provided in the second random access message (Msg2), the UE 104 can transmit a third random access message (Msg3) on the PUSCH (Physical Uplink Shared Channel). The third random access message (Msg3) can include a Radio Resource Control (RRC) message (e.g., RrcRequest) and/or uplink data (e.g., physical (PHY) data).

At the fourth step 240 of the four-step RACH procedure 200, the NE 102 (e.g., 5G base station, gNB) can transmit a fourth random access message (Msg4) having contention resolution information. For instances, after processing the third random access message (Msg3), the gNB can send the fourth random access message (Msg4) to the UE 104. The fourth random access message (Msg4) can include MAC data for contention resolution. The contention resolution message can include the UE's identity, confirming that the gNB has correctly identified the UE, and contention has been resolved. At this step, the network provides the UE with a Cell Radio Network Temporary Identifier (C-RNTI).

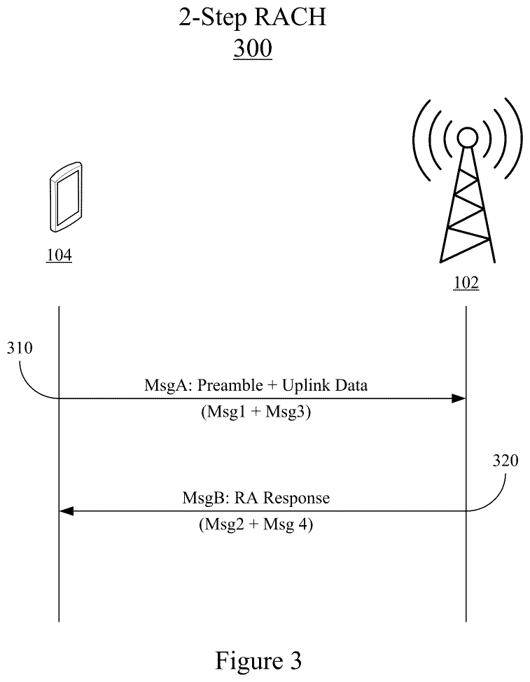

FIG. 3 illustrates an example of two-step RACH procedure in accordance with aspects of the present disclosure. The two-step RACH procedure 300 was proposed in NR to reduce the latency and potentially handshake overhead. The two-step RACH procedure 300 consists of one round trip transfer of control signaling between UE and gNB. A two-step RACH procedure 300 can include a first step 310 and a second step 320.

At the first step 310 of the two-step RACH procedure 300, the UE 104 can transmit a first random access message (MsgA) to the NE 102 (e.g., gNB). In this first random access message (MsgA) of the two-step RACH procedure 300, the UE 104 combines the preamble in the first random access message (Msg1) of the four-step RACH procedure 200 and the uplink data in the third random access message (Msg3) of the four-step RACH procedure 200.

At the second step 320 of the two-step RACH procedure 300, the NE 102 can transmit a second random access message (MsgB) to the UE 104. In this second random access message (MsgB) of the two-step RACH procedure 300, the gNB combines the second random access message (Msg2) of the four-step RACH procedure 200 and the fourth random access message (Msg4) of the four-step RACH procedure 200.

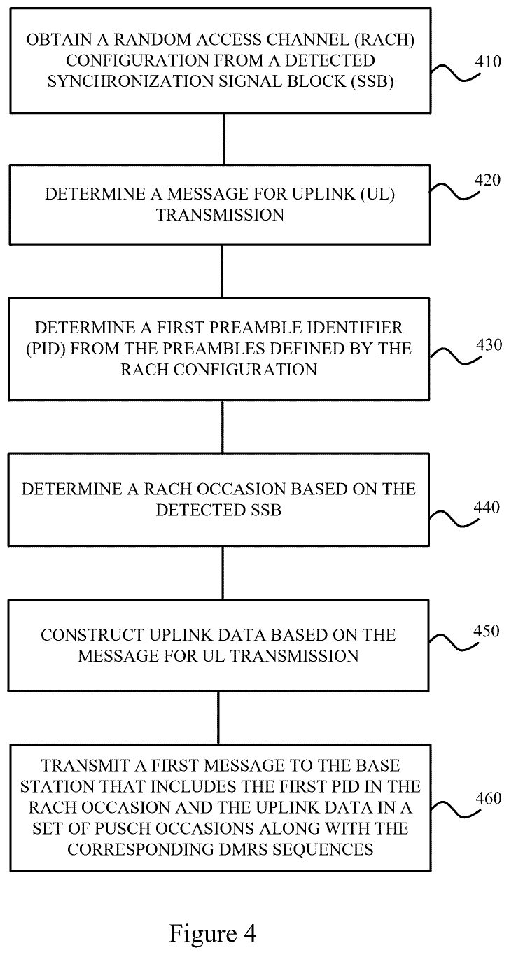

FIG. 4 illustrates a flowchart of a method associated with a UE transmitting a first random access message (MsgA) of a two-step RACH procedure in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged, omitted, expanded, or otherwise modified and that other implementations are possible.

According to some embodiments, the communication system can include a RACH occasion that occupies a number ‘T’ of resource blocks (RBs), where ‘T’ is not larger than the operation bandwidth (BW) of a UE 104 (e.g., LPWA UE). Additionally, a RACH occasion can be associated with a set of time-frequency resources and a set of preambles. For example, the communication system can have T=12 RBs and have long preamble for RACH operation.

At operation 410, the UE 104 can obtain a RACH configuration. For example, the UE 104 can detect a Synchronization Signal Block (SSB). The UE can decode a Physical Broadcast Channel (PBCH) based on the detected SSB. Subsequently, based on the decoded PBCH, the UE 104 can decode a System Information Block #1 (SIB1) message that includes a RACH configuration.

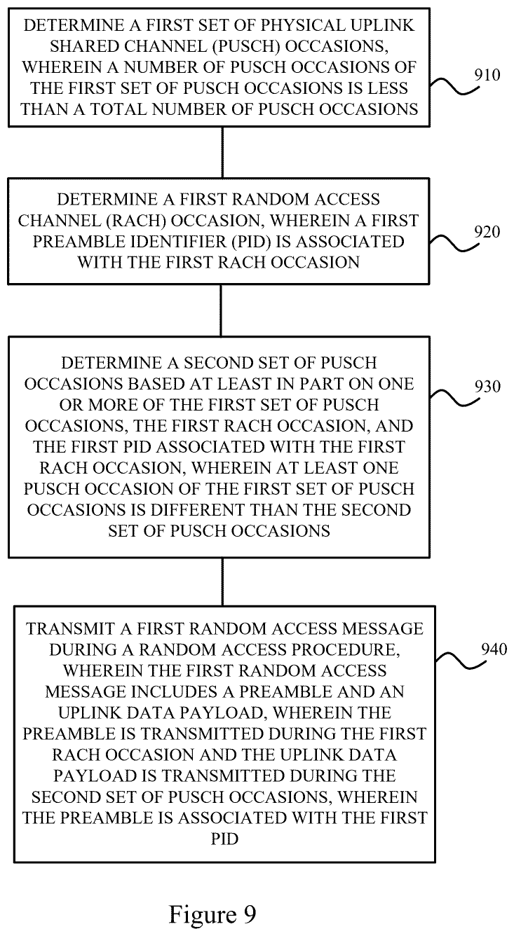

At operation 420, the UE 104 can determine a message for UL transmission. The message can include uplink data payload that is transmitted at operation 940 in FIG. 9.

At operation 430, the UE 104 can determine a first PID from the preambles defined by the RACH configuration. For instances, the UE 104 can determine the first PID based on a function of the message. For example, the UE 104 can perform a hashing function to the uplink data to determine the first PID. Alternatively, the UE 104 can randomly select the first PID.

In some instances, the first PID can be associated with a set of ‘n_s’ PUSCH occasion indices and corresponding pilot/DMRS sequences. The second set of PUSCH occasions (e.g., ‘n_s’ PUSCH occasion indices) can be selected, using mapping information, from a total number of PUSCH occasions (e.g., set of {1 . . . , N} PUSCH occasion indices). The mapping information can include a set of association patterns as illustrated in table 1 Additionally, the first set of {1 . . . , N} PUSCH occasion indices can be obtained from the RACH configuration. Moreover, one or more pilot/DMRS sequence(s) for a PUSCH occasion can be associated with two or more preambles.

At operation 440, the UE 104 can determine a RACH occasion based on the detected SSB. In some instances, the UE 104 can determine the RACH occasion based on the RACH configuration. Additionally, the UE can determine the first set of PUSCH occasions (e.g., corresponding ‘N’ number of PUSCH occasions in a time-frequency grid). The ‘N’ number of PUSCH occasions can be indexed according to mapping information. The table 1 below illustrates an example association mapping (e.g., RACH occasion (RO) to PUSCH occasion (PO) mapping). For example, as emphasized, (RO1, PID1) is mapped to {(PO1, DMRS1), and (PO4, DMRS2)} in table 1.

TABLE 1
Association Mapping Example

| | |
|---|---|
| PO1 DMRS Resource Index 0 | RO1 PID 0, RO2 PID3, RO3 PID1, RO4 |
| (Association Pattern 0) | PID 7 |
| PO1 DMRS Resource Index 1 | RO1 PID 1, RO2 PID4, RO3 PID2, RO4 |
| | PID 0 |
| PO1 DMRS Resource Index 2 | RO1 PID 2, RO2 PID5, RO3 PID3, RO4 |
| | PID 1 |
| PO1 DMRS Resource Index 3 | RO1 PID 3, RO2 PID6, RO3 PID4, RO4 |
| | PID 2 |
| PO2 DMRS Resource Index 0 | RO1 PID 4, RO2 PID7, RO3 PID5, RO4 |
| | PID 3 |
| PO2 DMRS Resource Index 1 | RO1 PID 5, RO2 PIDO, RO3 PID6, RO4 |
| | PID 4 |
| PO2 DMRS Resource Index 2 | RO1 PID 6, RO2 PID1, RO3 PID7, RO4 |
| | PID 5 |
| PO2 DMRS Resource Index 3 | RO1 PID 7, RO2 PID2, RO3 PIDO, RO4 |
| | PID 6 |
| PO3 DMRS Resource Index 0 | RO1 PID 3, RO2 PID6, RO3 PID7, RO4 |
| (Association Pattern 1) | PID 3 |
| PO3 DMRS Resource Index 1 | RO1 PID 4, RO2 PID7, RO3 PIDO, RO4 |
| | PID 4 |
| PO3 DMRS Resource Index 2 | RO1 PID 5, RO2 PIDO, RO3 PID1, RO4 |
| | PID 5 |
| PO3 DMRS Resource Index 3 | RO1 PID 6, RO2 PID1, RO3 PID2, RO4 |
| | PID 6 |
| PO4 DMRS Resource Index 0 | RO1 PID 7, RO2 PID2, RO3 PID3, RO4 |
| | PID 7 |
| PO4 DMRS Resource Index 1 | RO1 PID 0, RO2 PID3, RO3 PID4, RO4 |
| | PID 0 |
| PO4 DMRS Resource Index 2 | RO1 PID 1, RO2 PID4, RO3 PID5, RO4 |
| | PID 1 |
| PO4 DMRS Resource Index 3 | RO1 PID 2, RO2 PID5, RO3 PID6, RO4 |
| | PID 2 |

For instance, table 1 highlights that Association Pattern 0 is applicable to (PO1,DMRSO), (PO1, DMRS1), (PO1, DMRS2), (PO1, DMRS3), and (PO2, DMRSO), (PO2, DMRS1), (PO2, DMRS2), (PO2, DMRS3). Additionally, Association Pattern 1 is applicable to (PO3, DMRSO), (PO3, DMRS1), (PO3, DMRS2), (PO3, DMRS3), and (PO4, DMRSO), (PO4, DMRS1), (PO4, DMRS2), (PO4, DMRS3).

According to some embodiments, the mapping can ensures the n_s indices are not mapped to two occasions which are frequency division multiplexed in the same time index/unit (at least when non-consecutive in frequency domain), which can reduce the likelihood of two UEs transmitting in the same time-frequency resource.

At operation 450, the UE 104 can construct a first random access message with uplink data payload (e.g., an UL transmission) based on the message for UL transmission and a preamble. The uplink data can be constructed by encoding the message, repeating the encoded codeword, and so on.

At operation 460, the UE 104 can transmit a first random access message (MsgA) of a two-step RACH procedure to a base station. The first random access message can include the first PID in the RACH occasion and the uplink data in the associated set of ‘n_s’ PUSCH occasions along with the corresponding DMRS sequences.

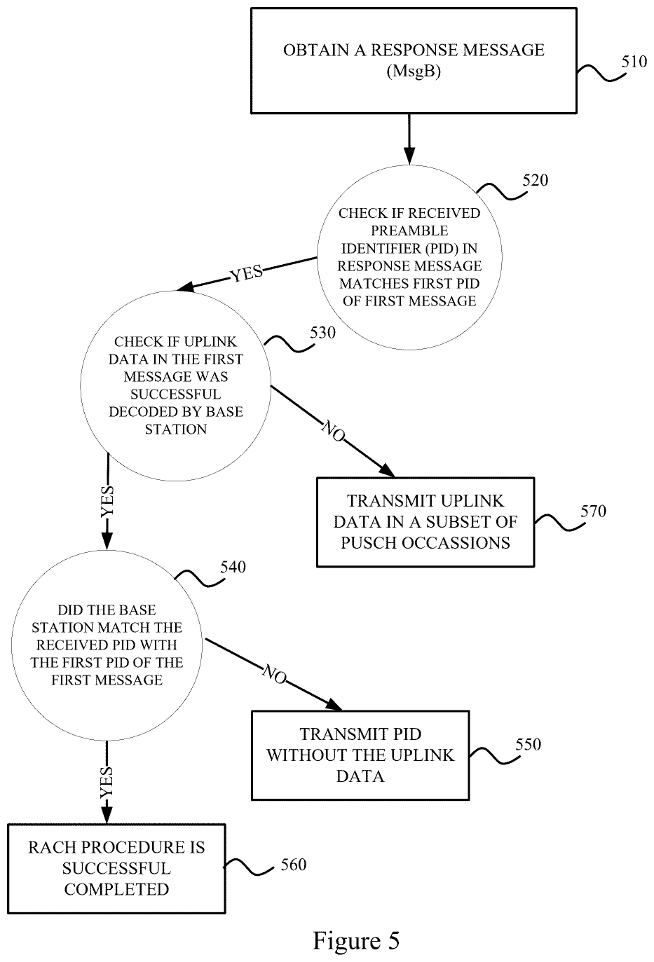

FIG. 5 illustrates a flowchart of a method associated with a UE receiving a second random access message (MsgB) during the second step of a two-step RACH procedure in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

In some instances, after the transmission of the first random access message at operation 460, the UE 104 can determine a reference time for determination of the msgB-ResponseWindow. For example, the UE can determine the msgB-ResponseWindow based on the determined reference time.

Additionally, the UE 104 can monitor a downlink control information (DCI) format (e.g., DCI Format 1_0) within the msgB-ResponseWindow. Upon reception of a physical downlink control channel (PDCCH) with the DCI format, the UE 104 checks if the system frame number (SFN) in which the PDCCH is received corresponds to the SFN in which the UE 102 has sent the preamble (e.g., RACH preamble) at operation 460. Moreover, the PDCCH can schedules a Physical Downlink Shared Channel (PDSCH).

At operation 510, the UE 104 can obtain a second random access message (MsgB) from the base station. For instances, if the PDSCH contains MsgB, the UE 104 decodes the PDSCH and obtains MsgB information. In some implementations, aspects of the operations of 510 may be performed by a UE as described with reference to FIG. 3. For example, the UE 104 can receive the second random access message (MsgB) that is transmitted by the NE 102 in step 320.

At operation 520, the UE 104 can check whether the received PID matches the first PID that was transmitted in the first random access message (MsgA-PRACH). In some instances, the first random access message can be transmitted by the UE at operation 460. Additionally, the received PID can be calculated by the base station using the uplink data that was transmitted at operation 460.

At operation 530, if the received PID matches the first PID transmitted in MsgA, then the UE 104 checks whether the base station (e.g., gNB) decoded the uplink data sent in MsgA.

At operation 540, when the uplink data was successfully decoded, the message can indicate whether the gNB has not been able to match the detected PID with the PID determined after hashing the decoded uplink data.

At operation 550, when the uplink data was successfully decoded but the MsgB message may indicate that the gNB has not been able to match the detected PID with the PID determined after hashing the decoded uplink data, then the MsgB instead may instruct the UE 104 to transmit a PID without sending a PUSCH (e.g., without resending the uplink data). In this scenario, the PID that was transmitted in MsgA may have been corrupted. Thus, the second random access message may also include an indication that the PID (e.g., first PID) is corrupted, and thus retransmit the PID without the uplink data in the message.

At operation 560, when the uplink data was successfully decoded and the MsgB message may indicate that the gNB has matched the detected PID with the PID determined after hashing the decoded uplink data, then the UE 104 can determine that the RACH procedure is successfully completed.

At operation 570, when the uplink data is not successfully decoded by the base station, the UE 104 can process the time advancing (TA) command and applies the uplink grant for transmission of Msg3 using the received temporary C-RNTI. Additionally, the second random access message may indicates how many of the set of PUSCH occasions (e.g., n_s PUSCH occasions) should be retransmitted. Moreover, the second random access message may indicate which PUSCH occasions of the set of PUSCH occasions should be retransmitted. For example, MsgB may indicate a subset associated with the first set of PUSCH occasions for the uplink data to be transmitted.

In some instances (not illustrated in FIG. 5), when the UE does not receive a second random access message (MsgB) from the gNB, then the UE 104 can continue to decode until the expiry of msgB-ResponseWindow. If the UE 104 does not receive a valid response from the network during the msgB-Response Window, the UE 104 can either retransmit MsgA (with same or different RACH preamble) or falls back to 4-step RA type and starts transmitting Msg1.

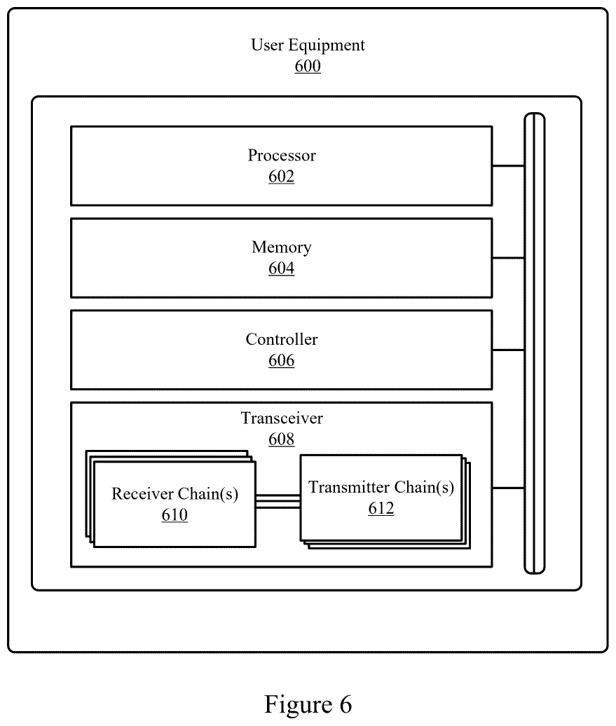

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for obtaining a RACH configuration; determining, based on the RACH configuration, a total number of physical uplink channel (PUSCH) occasions and a first set of PUSCH occasions; determining a first RACH occasion based on the RACH configuration; determining a first PID from a plurality of PIDs; determining a second set of PUSCH occasions based on the first set of PUSCH occasions, the first RACH occasion, and the first PID; and transmitting a first random access message to a base station, the first random access message having the first PID in the first RACH occasion and uplink data in the second set of PUSCH occasions.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

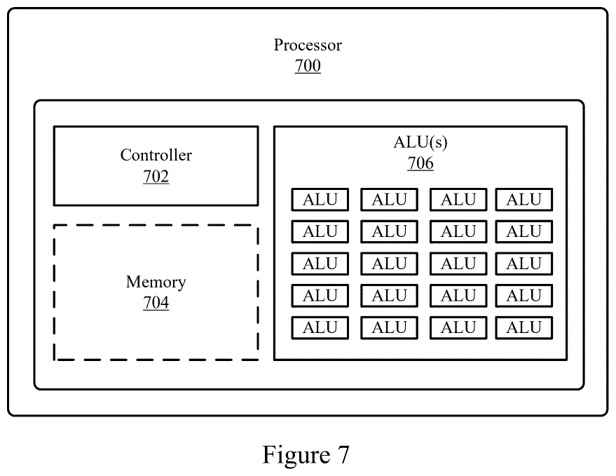

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for obtaining a RACH configuration; determining, based on the RACH configuration, a total number of physical uplink channel (PUSCH) occasions and a first set of PUSCH occasions; determining a first RACH occasion based on the RACH configuration; determining a first PID from a plurality of PIDs; determining a second set of PUSCH occasions based on the first set of PUSCH occasions, the first RACH occasion, and the first PID; and transmitting a first random access message to a base station, the first random access message having the first PID in the first RACH occasion and uplink data in the second set of PUSCH occasions.

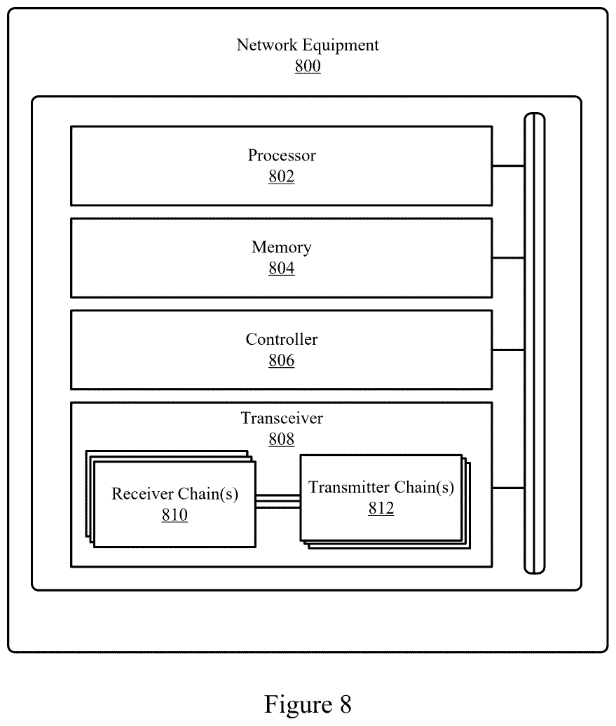

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for receiving a first random access message a UE, the first random access message having a first PID in a first RACH occasion and uplink data in a set of PUSCH occasions; decoding the first PID from the received first random access message; determining the set of PUSCH occasions based on the decoded first PID; decoding the uplink data based on the determined set of PUSCH occasions; determining, using a hashing function, a second PID based on the decoded uplink data; determining whether the first PID matches the second PID; generating a second random access message based on the determination of whether the first PID matches the second PID; and transmitting the second random access message to the UE.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

In some instances, the method may include obtaining a RACH configuration. The RACH configuration can define a plurality of preamble identifiers (PIDs) and a total number of PUSCH occasions.

In some instances, prior to obtaining the RACH configuration, the UE can detect a synchronization signal block (SSB). The SSB can include a physical broadcast channel (PBCH). The UE can decode the PBCH to obtain a system information block type 1 (SIB1) message. The RACH configuration can be obtained from the SIB1 message.

At 910, the method may include determining a first set of PUSCH occasions. Additionally, the number of PUSCH occasions of the first set of PUSCH occasions can be less than a total number of PUSCH occasions. The total number of PUSCH occasions can be defined in the RACH configuration. The operations of 910 may be performed in accordance with examples as described herein. In some implementations, aspects of the operations of 910 may be performed by a UE as described with reference to FIG. 6.

At 920, the method may include determining a first RACH occasion. Additionally, a first PID can be associated with the first RACH occasion. The operations of 920 may be performed in accordance with examples as described herein. In some implementations, aspects of the operations of 920 may be performed by a UE as described with reference to FIG. 6.

In some instances, the method can include receiving a random access configuration. The random access configuration can indicate one or more of the total number of PUSCH occasions or a plurality of PIDs. Additionally, the first PID is selected from the plurality of PIDs.

In some instances, the method can include computing a value by applying a function to at least a portion of the uplink data payload. Additionally, the method can include determining the first PID based at least in part on the computed value. For example, the value can be a hash value, and the function can be a hash function.

In some instances, the method can include randomly selecting the first PID from a plurality of PIDs. As previously mentioned, the RACH configuration can define the plurality of PIDs.

In some instances, the uplink data payload can include an indication that the first PID is selected randomly or selected based on the uplink data payload.

At 930, the method may include determining a second set of PUSCH occasions based at least in part on one or more of the first set of PUSCH occasions, the first RACH occasion, and the first PID associated with the first RACH occasion. Additionally, at least one PUSCH occasion of the first set of PUSCH occasions can be different than the second set of PUSCH occasions. The operations of 930 may be performed in accordance with examples as described herein. In some implementations, aspects of the operations of 930 may be performed by a UE as described with reference to FIG. 6.

In some instances, the method can include receiving mapping information that maps a set of PUSCH occasions with a pair of RACH occasion and PIDs. Additionally, one or more of the first set of PUSCH occasions or the second set of PUSCH occasions is based at least in part on the mapping information.

In some instances, the method can include determining a DMRS sequence for each PUSCH occasion of the second set of PUSCH occasions based at least in part on a mapping rule. The DMRS sequence for each PUSCH occasion of the second set of PUSCH occasions can be based at least in part on the first PID and the first RACH occasion.

In some instances, the first random access message can include a DMRS sequence for each PUSCH occasion of the second set of PUSCH occasions.

As previously described at operation 430 in FIG. 4, the first PID can be associated with a set of ‘n_s’ PUSCH occasion indices and corresponding DMRS sequences. The ‘n_s’ PUSCH occasion indices can be selected, using received mapping information, from a total number of PUSCH occasions (e.g., a set of {1 . . . , N} PUSCH occasion indices). The mapping information can include a set of association patterns as illustrated in table 1. The total number of PUSCH occasions can be defined in the RACH configuration.

At 940, the method may include transmitting a first random access message during a random access procedure. The first random access message can include a preamble and an uplink data payload. Additionally, the preamble can be transmitted during the first RACH occasion and the uplink data payload can transmitted during the second set of PUSCH occasions. Moreover, the preamble can be associated with the first PID. The operations of 940 may be performed in accordance with examples as described herein. In some implementations, aspects of the operations of 940 may be performed by a UE as described with reference to FIG. 6.

In some instances, the method can include receiving mapping information that maps a pair of RACH occasions and PIDs with a pair of PUSCH occasions and DMRS sequences. Additionally, the first random access message can include the DMRS sequences.

In some instances, the method can include determining a random access response window based at least in part on the second set of PUSCH occasions. Additionally, the method can include receiving a second random access message during the random access response window.

In one embodiment, the second random access message can indicate a successful decoding of the uplink data payload. Additionally, the second random access message can further indicate a failure to match the first PID with a second PID. The second PID can be based at least in part on the uplink data payload. Moreover, the method can include transmitting a third random access message that includes the first PID. In one example, the third random access message can excludes the uplink data payload.

In another embodiment, the second random access message can indicate an unsuccessful decoding of the uplink data payload. Additionally, the second random access message can further indicate a request to retransmit the uplink data payload. Moreover, the method can include retransmitting the uplink data payload during a subset of the second set of PUSCH occasions.

In some instances, the method can include receiving mapping information that maps a pair of RACH occasions and PIDs with a pair of PUSCH occasions and DMRS sequences. Additionally, the first random access message can include the DMRS sequences.

In some instances, the PUSCH can include a plurality of time-frequency slots. The plurality of time-frequency slots can correspond to a total number of PUSCH occasions. Additionally, the mapping information can associate a set of PUSCH occasions from the total number of PUSCH occasions for each {RACH occasion, PID} pair. Each PUSCH occasion in the set of PUSCH occasion can be associated with a time-frequency slot in the plurality of time-frequency slots.

In some embodiments, the UE can perform a two-step RACH procedure. In other embodiments, the UE can perform a two-step RACH procedure.

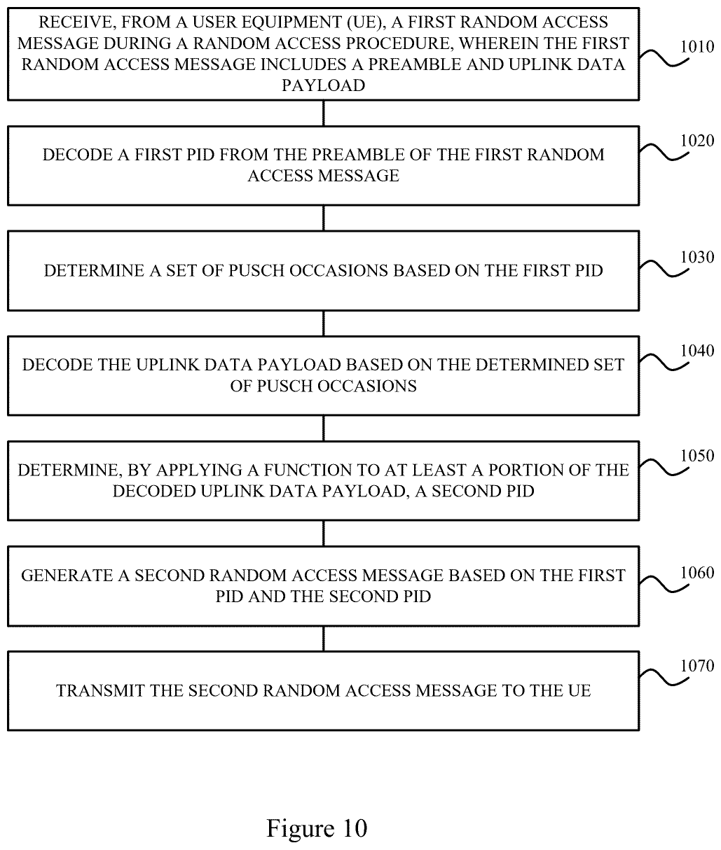

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1010, the method may include receiving, from a UE, a first random access message during a random access procedure. The first random access message can include a preamble and uplink data payload. Additionally, the preamble can be transmitted during the first RACH occasion and the uplink data payload can transmitted during the second set of PUSCH occasions. Moreover, the preamble can be associated with the first PID. The operations of 1010 may be performed in accordance with examples as described herein. In some implementations, aspects of the operations of 1010 may be performed by a NE as described with reference to FIG. 8.

At 1020, the method may include decoding a first PID from the preamble of the first random access message. The operations of 1020 may be performed in accordance with examples as described herein. In some implementations, aspects of the operations of 1020 may be performed by a NE as described with reference to FIG. 8.

At 1030, the method may include determining a set of PUSCH occasions based on the first PID. The operations of 1030 may be performed in accordance with examples as described herein. In some implementations, aspects of the operations of 1030 may be performed by a NE as described with reference to FIG. 8.

At 1040, the method may include decoding the uplink data payload based on the determined set of PUSCH occasions. The operations of 1040 may be performed in accordance with examples as described herein. In some implementations, aspects of the operations of 1040 may be performed by a NE as described with reference to FIG. 8.

At 1050, the method may include determining, by applying a function to at least a portion of the decoded uplink data payload, a second PID. The operations of 1050 may be performed in accordance with examples as described herein. In some implementations, aspects of the operations of 1050 may be performed by a NE as described with reference to FIG. 8.

At 1060, the method may include generate a second random access message based on the first PID and the second PID. The operations of 1060 may be performed in accordance with examples as described herein. In some implementations, aspects of the operations of 1060 may be performed by a NE as described with reference to FIG. 8.

In some instances, the method may include generating the second random access message based on the determination of whether the first PID matches the second PID.

In a first scenario, when the base station determines that the first PID matches the second PID. The second random access message can includes an indication that the first PID matches the second PID. Additionally, the second random access message can include a confirmation that a random access procedure is successfully completed. An example of this scenario is described at operation 560 in FIG. 5.

In a second scenario, when the base station can determines that the first PID does not match the second PID. The second random access message can includes a confirmation that the base station has successfully decoded the uplink data payload in the first random access message. Additionally, the second random access message can include an indication that the first PID does not match the second PID. Moreover, the second random access message can include a request for the UE to transmit a third random access message that includes the first PID, wherein the third random access message excludes the uplink data payload. For example, the message can include an indication that the received first PID is corrupt, and thus for the UE to retransmit the first PID. An example of this scenario is described at operation 550 in FIG. 5.

In a third scenario, the base station can determine that the decoded uplink data payload is corrupted. For example, the uplink data payload can be corrupted when a collision has occurred of messages transmitted by different UEs. Additionally the second random access message that is generated at 1060 can be further based on the determination that the decoded uplink data is corrupt. The second random access message can include an indication of an unsuccessful decoding of the uplink data payload. Additionally, the second random access message can include a request to retransmit the uplink data payload during a subset of the determined set of PUSCH occasions. The subset of PUSCH occasions can be based on the second set of PUSCH occasions that was determined at operation 930 in FIG. 9. An example of this scenario is described at operation 570 in FIG. 5.

At 1070, the method may include transmitting the second random access message to the UE. The operations of 1070 may be performed in accordance with examples as described herein. In some implementations, aspects of the operations of 1080 may be performed by a NE as described with reference to FIG. 8.

In some instances, the base station can determine a random access response window based on the determined set of PUSCH occasions. Additionally, the second random access message can be transmitted during the random access response window.

The following provides an overview of aspects of the present disclosure:

Embodiment 1 relates to method for wireless communication. The method can be performed by a UE. The method can include determining a first set of PUSCH occasions, wherein a number of PUSCH occasions of the first set of PUSCH occasions is less than a total number of PUSCH occasions. Additionally, the method can include determining a first RACH occasion, wherein a first PID is associated with the first RACH occasion. Moreover, the method can include determining a second set of PUSCH occasions based at least in part on one or more of the first set of PUSCH occasions, the first RACH occasion, and the first PID associated with the first RACH occasion, wherein at least one PUSCH occasion of the first set of PUSCH occasions is different than the second set of PUSCH occasions. Furthermore, the method can include transmitting a first random access message during a random access procedure, wherein the first random access message includes a preamble and an uplink data payload, wherein the preamble is transmitted during the first RACH occasion and the uplink data payload is transmitted during the second set of PUSCH occasions, wherein the preamble is associated with the first PID.

Embodiment 2 includes the method of embodiment 1. In this embodiment, the method may include determining a random access response window based at least in part on the second set of PUSCH occasions. Additionally, the method can include receiving a second random access message during the random access response window.

Embodiment 3 includes the method of embodiment 2. In this embodiment, the second random access message can indicate a successful decoding of the uplink data payload, wherein the second random access message further indicates a failure to match the first PID with a second PID, wherein the second PID is based at least in part on the uplink data payload. Additionally, the method can include transmitting a third random access message that includes the first PID, wherein the third random access message excludes the uplink data payload.

Embodiment 4 includes the method of embodiment 2. In this embodiment, the second random access message can indicate an unsuccessful decoding of the uplink data payload. The second random access message can further indicate a request to retransmit the uplink data payload. Additionally, the method can include retransmit the uplink data payload during a subset of the second set of PUSCH occasions.

Embodiment 5 includes the method of any of embodiments 1 to 4. In this embodiment, the method may include computing a value by applying a function to at least a portion of the uplink data payload. Additionally, the method can include determining the first PID based at least in part on the computed value.

Embodiment 6 includes the method of embodiment 5. In this embodiment, the value can be a hash value, and the function can be a hash function.

Embodiment 7 includes the method of any of embodiments 1 to 4. In this embodiment, randomly select the first PID from a plurality of PIDs.

Embodiment 8 includes the method of any of embodiments 1 to 7. In this embodiment, the uplink data payload can include an indication that the first PID is selected randomly or selected based on the uplink data payload.

Embodiment 9 includes the method of any of embodiments 1 to 8. In this embodiment, the method can include determining a DMRS sequence for each PUSCH occasion of the second set of PUSCH occasions based at least in part on a mapping rule. Additionally, the DMRS sequence for each PUSCH occasion of the second set of PUSCH occasions can be based at least in part on the first PID and the first RACH occasion.

Embodiment 10 includes the method of any of embodiments 1 to 9. In this embodiment, the first random access message can include a DMRS sequence for each PUSCH occasion of the second set of PUSCH occasions.

Embodiment 11 includes the method of any of embodiments 1 to 10. In this embodiment, the method can include receiving mapping information that maps a pair of RACH occasions and PIDs with a pair of PUSCH occasions and DMRS sequences. Additionally the first random access message can further include the DMRS sequences.

Embodiment 12 includes the method of any of embodiments 1 to 11. In this embodiment, the method can include receiving mapping information that maps a set of PUSCH occasions with a pair of RACH occasion and PIDs. Additionally, the one or more of the first set of PUSCH occasions or the second set of PUSCH occasions can be based at least in part on the mapping information.

Embodiment 13 includes the method of any of embodiments 1 to 12. In this embodiment, the method can include receiving a random access configuration, wherein the random access configuration indicates one or more of the total number of PUSCH occasions or a plurality of PIDs. Additionally, the first PID can be selected from the plurality of PIDs.

Embodiment 14 relates to a UE for wireless communication. The UE can include one or more memories; and one or more processors coupled with the one or more memories and individually or collectively operable to cause the UE to perform the method described in any of embodiments 1 to 13.

Embodiment 15 relates to a processor comprising at least one controller coupled with at least one memory and configured to cause the processor to perform the method described in any of embodiments 1 to 13.

Embodiment 16 relates to method for wireless communication. The method can be performed by a base station. The method can include receiving, from a UE, a first random access message during a random access procedure, wherein the first random access message includes a preamble and uplink data payload. Additionally, the method can include decoding a first PID from the preamble of the first random access message. Moreover, the method can include determining a set of PUSCH occasions based on the first PID. Furthermore, the method can include decoding the uplink data payload based on the determined set of PUSCH occasions. The method can include determining, by applying a function to at least a portion of the decoded uplink data payload, a second PID. The method can include generating a second random access message based on the first PID and the second PID. Subsequently, the method can include transmitting the second random access message to the UE.

Embodiment 17 includes the method of embodiment 16. In this embodiment, the method may include determining a random access response window based on the determined set of PUSCH occasions. Additionally, the second random access message can be transmitted during the random access response window.

Embodiment 18 includes the method of embodiments 16 or 17. In this embodiment, the method may include determining that the first PID does not match the second PID. Additionally, the second random access message can includes: a confirmation that the base station has successfully decoded the uplink data payload in the first random access message; an indication that the first PID does not match the second PID; and a request for the UE to transmit a third random access message that includes the first PID, wherein the third random access message excludes the uplink data payload.

Embodiment 19 includes the method of embodiments 16 or 17. In this embodiment, the method may include determining that the first PID matches the second PID. Additionally, the second random access message can includes: an indication that the first PID matches the second PID; and a confirmation that a random access procedure is successfully completed.

Embodiment 20 includes the method of embodiments 16 or 17. In this embodiment, the method may include determine that the decoded uplink data payload is corrupted. Additionally, the second random access message can be further generated based on the determination that the decoded uplink data is corrupt. The second random access message can include: an indication of an unsuccessful decoding of the uplink data payload; and a request to retransmit the uplink data payload during a subset of the determined set of PUSCH occasions.

Embodiment 21 relates to a base station for wireless communication. The base station can include one or more memories; and one or more processors coupled with the one or more memories and individually or collectively operable to cause the base station to perform the method described in any of embodiments 16 to 20.

Embodiment 22 relates to a processor comprising at least one controller coupled with at least one memory and configured to cause the processor to perform the method described in any of embodiments 16 to 20.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description provided herein, along with the accompanying figures, illustrates certain example implementations and is not intended to encompass all possible implementations within the scope of the claims. As used herein, the term “example” is intended to convey an illustration or instance, and does not imply a preferred or superior implementation. The detailed description includes specific features and elements to facilitate understanding of the implementations described in the present disclosure. However, these implementations may also be realized without some or all of the specified details.

What is claimed is:

1. A user equipment (UE) for wireless communication, comprising:
one or more memories; and
one or more processors coupled with the one or more memories and individually or collectively operable to cause the UE to:
determine a first set of physical uplink shared channel (PUSCH) occasions, wherein a number of PUSCH occasions of the first set of PUSCH occasions is less than a total number of PUSCH occasions;
determine a first random access channel (RACH) occasion, wherein a first preamble identifier (PID) is associated with the first RACH occasion;
determine a second set of PUSCH occasions based at least in part on one or more of the first set of PUSCH occasions, the first RACH occasion, and the first PID associated with the first RACH occasion, wherein at least one PUSCH occasion of the first set of PUSCH occasions is different than the second set of PUSCH occasions; and
transmit a first random access message during a random access procedure, wherein the first random access message includes a preamble and an uplink data payload, wherein the preamble is transmitted during the first RACH occasion and the uplink data payload is transmitted during the second set of PUSCH occasions, wherein the preamble is associated with the first PID.

2. The UE of claim 1, wherein the one or more processors are further individually or collectively configured to cause the UE to:
determine a random access response window based at least in part on the second set of PUSCH occasions; and
receive a second random access message during the random access response window.

3. The UE of claim 2, wherein the second random access message indicates a successful decoding of the uplink data payload, wherein the second random access message further indicates a failure to match the first PID with a second PID, wherein the second PID is based at least in part on the uplink data payload, and
wherein the one or more processors are further individually or collectively configured to cause the UE to:
transmit a third random access message that includes the first PID, wherein the third random access message excludes the uplink data payload.

4. The UE of claim 2, wherein the second random access message indicates an unsuccessful decoding of the uplink data payload, wherein the second random access message further indicates a request to retransmit the uplink data payload,
wherein the one or more processors are further individually or collectively configured to cause the UE to:
retransmit the uplink data payload during a subset of the second set of PUSCH occasions.

5. The UE of claim 1, wherein the one or more processors are further individually or collectively configured to cause the UE to:
compute a value by applying a function to at least a portion of the uplink data payload; and
determine the first PID based at least in part on the computed value.

6. The UE of claim 5, wherein the value comprises a hash value, and wherein the function comprises a hash function.

7. The UE of claim 1, wherein the one or more processors are further individually or collectively configured to cause the UE to:
randomly select the first PID from a plurality of PIDs.

8. The UE of claim 1, wherein the uplink data payload includes an indication that the first PID is selected randomly or selected based on the uplink data payload.

9. The UE of claim 1, wherein the one or more processors are further individually or collectively configured to cause the UE to:
determine a demodulation reference signal (DMRS) sequence for each PUSCH occasion of the second set of PUSCH occasions based at least in part on a mapping rule,
wherein the DMRS sequence for each PUSCH occasion of the second set of PUSCH occasions is based at least in part on the first PID and the first RACH occasion.

10. The UE of claim 1, wherein the first random access message includes a demodulation reference signal (DMRS) sequence for each PUSCH occasion of the second set of PUSCH occasions.

11. The UE of claim 1, wherein the one or more processors are further individually or collectively configured to cause the UE to:
receive mapping information that maps a pair of RACH occasions and PIDs with a pair of PUSCH occasions and DMRS sequences, wherein the first random access message further includes the DMRS sequences.

12. The UE of claim 1, wherein the one or more processors are further individually or collectively configured to cause the UE to:
receive mapping information that maps a set of PUSCH occasions with a pair of RACH occasion and PIDs,
wherein one or more of the first set of PUSCH occasions or the second set of PUSCH occasions is based at least in part on the mapping information.

13. The UE of claim 1, wherein the one or more processors are further individually or collectively configured to cause the UE to:
receive a random access configuration, wherein the random access configuration indicates one or more of the total number of PUSCH occasions or a plurality of PIDs,
wherein the first PID is selected from the plurality of PIDs.

14. A processor comprising at least one controller coupled with at least one memory and configured to cause the processor to:
determine a first set of physical uplink shared channel (PUSCH) occasions, wherein a number of PUSCH occasions of the first set of PUSCH occasions is less than a total number of PUSCH occasions;
determine a first random access channel (RACH) occasion, wherein a first preamble identifier (PID) is associated with the first RACH occasion;
determine a second set of PUSCH occasions based at least in part on one or more of the first set of PUSCH occasions, the first RACH occasion, and the first PID associated with the first RACH occasion, wherein at least one PUSCH occasion of the first set of PUSCH occasions is different than the second set of PUSCH occasions; and
cause a transmission of a first random access message during a random access procedure, wherein the first random access message includes a preamble and an uplink data payload, wherein the preamble is transmitted during the first RACH occasion and the uplink data payload is transmitted during the second set of PUSCH occasions, wherein the preamble is associated with the first PID.

15. A method performed or performable by a user equipment (UE), the method comprising:
determining a first set of physical uplink shared channel (PUSCH) occasions, wherein a number of PUSCH occasions of the first set of PUSCH occasions is less than a total number of PUSCH occasions;
determining a first random access channel (RACH) occasion, wherein a first preamble identifier (PID) is associated with the first RACH occasion;
determining a second set of PUSCH occasions based at least in part on one or more of the first set of PUSCH occasions, the first RACH occasion, and the first PID associated with the first RACH occasion, wherein at least one PUSCH occasion of the first set of PUSCH occasions is different than the second set of PUSCH occasions; and
transmitting a first random access message during a random access procedure, wherein the first random access message includes a preamble and an uplink data payload, wherein the preamble is transmitted during the first RACH occasion and the uplink data payload is transmitted during the second set of PUSCH occasions, wherein the preamble is associated with the first PID.

16. A base station for wireless communication, comprising:
one or more memories; and
one or more processors coupled with the one or more memories and individually or collectively operable to cause the base station to:
receive, from a user equipment (UE), a first random access message during a random access procedure, wherein the first random access message includes a preamble and uplink data payload;
decode a first PID from the preamble of the first random access message;
determine a set of PUSCH occasions based on the first PID;
decode the uplink data payload based on the determined set of PUSCH occasions;
determine, by applying a function to at least a portion of the decoded uplink data payload, a second PID;
generate a second random access message based on the first PID and the second PID; and
transmit the second random access message to the UE.

17. The base station of claim 16, wherein the one or more processors cause the base station to:
determine a random access response window based on the determined set of PUSCH occasions, and
wherein the second random access message is transmitted during the random access response window.

18. The base station of claim 16, wherein the one or more processors are further individually or collectively configured to cause the base station to:
determines that the first PID does not match the second PID, and
wherein the second random access message includes:
a confirmation that the base station has successfully decoded the uplink data payload in the first random access message;
an indication that the first PID does not match the second PID; and
a request for the UE to transmit a third random access message that includes the first PID, wherein the third random access message excludes the uplink data payload.

19. The base station of claim 16, wherein the one or more processors are further individually or collectively configured to cause the base station to:
determines that the first PID matches the second PID, and
wherein the second random access message includes:
an indication that the first PID matches the second PID; and
a confirmation that a random access procedure is successfully completed.

20. The base station of claim 16, wherein the one or more processors are further individually or collectively configured to cause the base station to:
determine that the decoded uplink data payload is corrupted, wherein the second random access message is further generated based on the determination that the decoded uplink data is corrupt, and wherein the second random access message includes:
an indication of an unsuccessful decoding of the uplink data payload; and
a request to retransmit the uplink data payload during a subset of the determined set of PUSCH occasions.
